(19) United States
(12) Patent Application Publication
(10) Pub. No.: US 2009/0192839 A1
(43) Pub. Date: Jul. 30, 2009

(54) SYSTEMS AND METHODS FOR PROVIDING CONTROLLED PROCESS EXECUTION

(76) Inventors: Krishnamoorthy Ramamoorthy, (US); Baljit Singh Gupta, (US); Ranvir Singh, (US)

Correspondence Address: TRAN & ASSOCIATES, 6768 MEADOW VISTA CT., SAN JOSE, CA, 95135, US

(21) Appl. No.: 12/020,566

(22) Filed: Jan. 27, 2008

(51) Int. Cl. G06F 17/40

(52) U.S. Cl. 705/7

(57) ABSTRACT

Systems and methods are disclosed to provide a controlled process execution in enterprise software by receiving one or more rules specifying the controlled process execution; capturing one or more activities performed by the enterprise software; determining whether the activities performed violates the one or more rules; and notifying the user of violations or exceptions caused by the activities.

### BACKGROUND

Ensuring that customers have properly deployed access controls and process execution controls across the enterprise is a top priority today. Regulatory mandates such as the Sarbanes-Oxley Act in the United States, Combined Code and the Turnbull Report in the United Kingdom, and KonTraG in Germany require organizations to prove that they have strong, effective access and authorization controls in place. In general, access control to an information resource is based on a reference monitor evaluating an access request against a static set of access rights associated to a principle or role. However, context information may also be taken into consideration to decide whether access should or should not be granted. Such context may be the operations a user has already executed in a workflow, the business objects he accessed in the past but also more abstract context like temperature or location. This, however, raises a set of problems that no current system appears to address satisfactorily.

To address this need, vendors offer access control applications for monitoring, testing, and enforcing access and authorization controls across the enterprise. One vendor known as SAP provides these applications as part of the SAP GRC solutions for governance, risk, and compliance (SAP solutions for GRC), include Virsa Compliance Calibrator, Virsa Access Enforcer, Virsa Role Expert, and the Virsa FireFighter application for SAP. These solutions require customers to deploy the software correctly and adjust it to fit the organization's own regulatory and industry-specific needs. The enterprise may have thousands of access rights-related rules and interdependencies across the enterprise application systems.

In an SAP system, business transactions can be executed at any time of day regardless of the criticality of the transaction, for example, check payment, payroll processing, month-end close, physical inventory, among others. Time-based policies and procedures cannot be implemented for a business process execution in the SAP system.

### SUMMARY OF THE INVENTION

In one aspect, systems and methods are disclosed to provide a controlled process execution in an enterprise software by receiving one or more rules specifying the controlled process execution; capturing one or more activities performed by the enterprise software; determining whether the activities performed violates the one or more rules; and notifying the user of violations or exceptions caused by the activities.

Implementations of the above aspect may include one or more of the following. The system can perform automated locking mechanism for a business process. The locking mechanism can be based on a freely definable locking calendar. An automated monitoring framework can gather business process execution statistics. The system can provide analytical reports on exceptions, business process execution frequency, usage by process, transaction, user or time. A built-in approval workflow can be used for maintaining a business process locking calendar. A user-based role proposal feature can be used to facilitate security design. A rule designer can be used to define a business process and setting up a rule to lock a business process based on a locking calendar to allow one or more pre-defined activities to be executed only during a predefined period. The predefined period comprises business hours or predetermined dates. The system can exercise control over a business process execution timing. The system can prevent inadvertent or deliberate activity during a predetermined time even if permitted by a user role. The system can utilize one or more enhancement hooks such as an SAP User Exit Add-in or an SAP Business Add-In. The system can ensure that one or more rules setup for temporary suspension or locking of a business process is not violated by directly unlocking the business process in a backend system. An analytics dashboard can be presented with reports to indicate exceptions, business process execution frequency by system, activity, or user. The system can collect data for a user role design based on actual usage rather than on an arbitrary request to avoid excessive authorization. The enterprise software can be an SAP system.

Preferred embodiments of the system may offer the following advantages. The system provides a calendar-driven automated mechanism to lock/unlock business transactions across an SAP System Landscape to contain untimely business process execution. The system can provide reports to show the actual usage frequency/timing of business transactions by user across SAP systems. The system provides tools to support efficient security role design based on actual usage statistics rather than arbitrary requests. The result is a reduction in the time, risk, and cost associated with operating the CRM system.

### BRIEF DESCRIPTION OF THE DRAWINGS

FIG. 1 shows an exemplary process for providing controlled process execution for enterprise software.

FIG. 2 shows an exemplary data collector process.

FIG. 3 shows an exemplary data collector.

FIG. 4 shows an exemplary business process validation flowchart.

FIG. 5 shows an exemplary process for validation of a transaction code.

FIG. 6 shows an exemplary process to run incremental job on a remote system.

FIG. 7 shows an exemplary process to perform incremental synchronization on a local system.

FIG. 8 shows an exemplary process to validate and store a rules set.

FIG. 9 shows an exemplary process to perform activity analysis.

FIG. 10 shows an exemplary process to perform exception analysis.

FIG. 11 illustrates an exemplary client/server system used in implementing one or more embodiments of the invention.

FIG. 12 shows an exemplary computer system used in implementing an embodiment of the present invention.

### DESCRIPTION

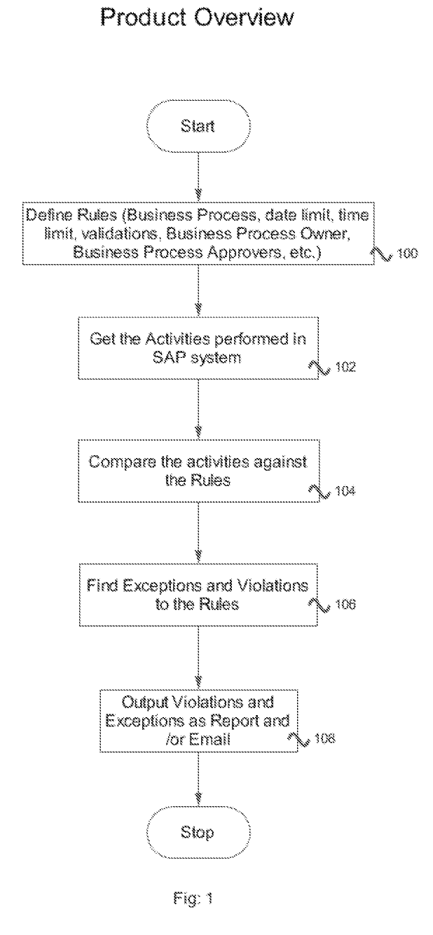

FIG. 1 shows an exemplary process guard system for providing controlled process execution for enterprise software. First, a user defines rules such as business processes, date limits, time limits, validations, business process owners, and business process approvers, among others (100). The system obtains the activities being performed in the SAP system (102). Next, the system compares the activities against the rules (104). If exceptions and violations exist, the system locates these issues (106) and outputs the violations and exceptions for user review (108). The output generated can be printed as a report or can be emailed to the user, among others.

The process guard of FIG. 1 utilizes the SAP enhancement hook and the SAP locking mechanisms. The enhancement hooks include the User Exit/BADI in the standard SAP performance collector job. The SAP locking/unlocking mechanism can be used for any business process step using transaction code SM01. The SAP facilities are used to aid controlled business process execution thereby complementing the user-centric access control solutions for GRC (Governance, Risk and Compliance) with a process-centric solution. Also the data collection process helps in proper user role design based on actual usage rather than arbitrary requests thereby establishing best practices to avoid excessive authorization.

In one embodiment, the process of FIG. 1 runs on the SAP NetWeaver platform and offers the following salient features. The system provides a Rule Designer to define a business process incorporating step(s) from SAP system(s) and set up a rule to lock a business process or processes based on a locking calendar so that certain critical activities can be carried out only during business hours or on certain dates such as month-end, year-end, etc. In simple terms, it helps process governance by exercising better control over the timing of a business process execution thereby preventing inadvertent or deliberate activity at a wrong time even if the user role permits it. The system also provides an approval workflow feature to implement the locking rule defined in step 100. A monitoring framework is provided for each one of the SAP Systems by utilizing enhancement hooks (User Exit or Business Add-In) provided by SAP to ensure that rules setup for temporary suspension/locking of the business processes are not violated by directly unlocking the business process in the backend SAP system(s). Additionally, an analytics dashboard can display reports to indicate exceptions, business process execution frequency by system, activity, user, among others. The system complements a user-centric access control methodology for corporate governance, risk and compliance initiative to the next level of process-centric methodology. The monitoring framework can also provide usage statistics for the different business process steps and help in refining user roles either manually or automatically based on actual usage rather than arbitrary requests.

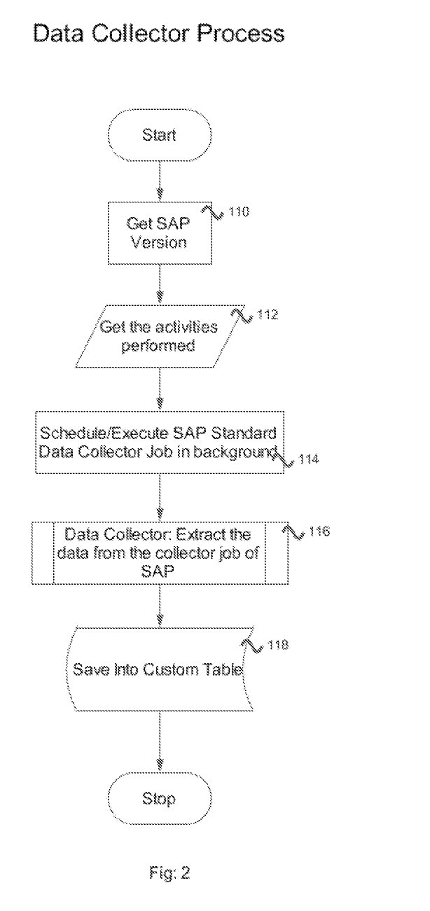

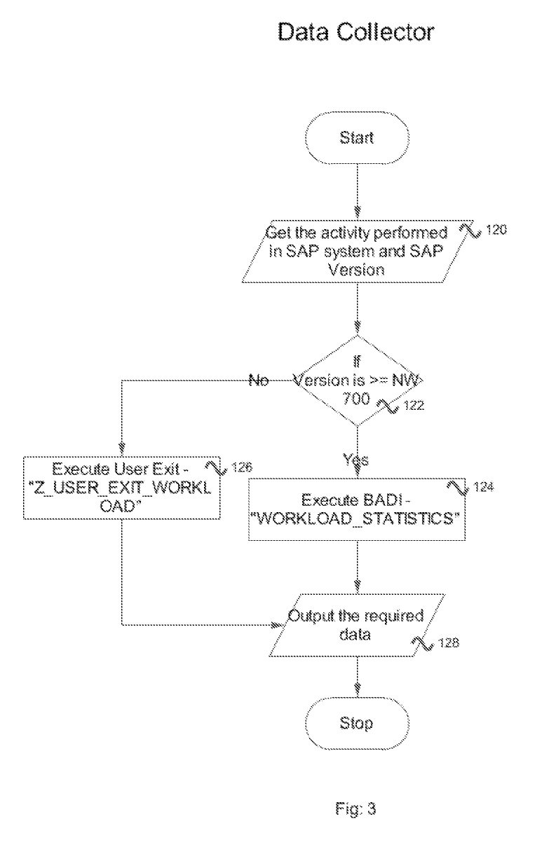

The SAP system collects performance data on an hourly basis when a standard job “COLLECTOR_FOR_PERFORMANCE_MONITOR” is scheduled. By default, the job is scheduled from the time of implementation. SAP has provided an enhancement hook (USER EXIT in releases up to 6.40 and a BADI—Business Add-In from release 700 upwards). The process of FIG. 2 enhances this enhanced hook even more to collect business-process relevant statistical data from each one of the monitored systems. FIG. 2 shows the data collector process. The process obtains the current software version (110). Next, the process obtains the activities to be performed (112). The process then schedules or executes an SAP standard data collector job of FIG. 3 in the background (114). The data collector extracts data from the collector job (116) and saves the information into a custom table (118).

FIG. 3 shows an exemplary data collector 114 in FIG. 2 where the branching is done based on the SAP Version to get the desired output for process guard of FIG. 1 to store in a custom table for subsequent use. The process collects data relating to the activity performed in the SAP system as well as the SAP version number (120). Next, the process determines if the version is greater than the NW700 version (122). If so, the process executes a routine to collect workload called “WORKLOAD_STATICS” (124) and if not, the process executes a user exit process called “Z_USER_EXIT_WORKLOAD” (126). The process then outputs the required data (128) and exits.

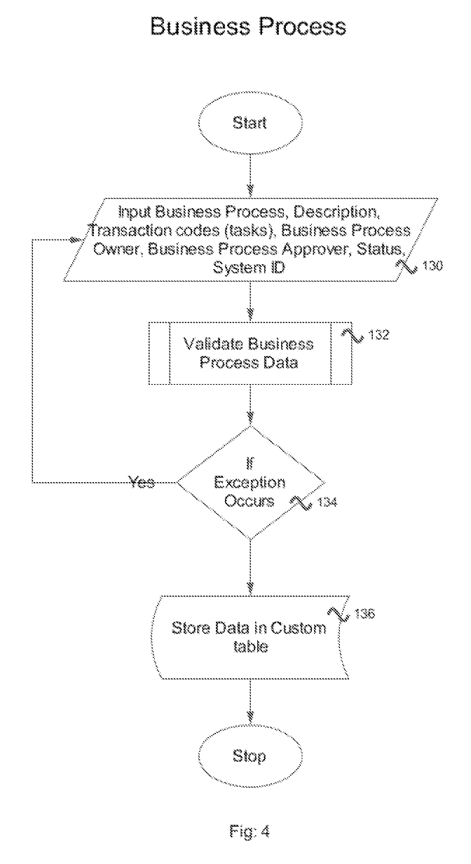

FIG. 4 shows an exemplary business process validation flowchart. This flowchart is part of the rule designer where the users can define a business process by incorporating steps from a single or multiple systems for a business scenario (for example, create sales order in a CRM system, check available-to-promise in an APO system and post goods issue in an R/3 system). The process receives as input the business process, description, transaction codes (tasks), business process owner, business process provider, status, and system identification (130). Next, the process validates the business process data (132). The process tests for exceptions (134). If exceptions occurred, the process loops back to 130. Alternatively, if no exceptions occurred, the process stores the data in a custom table (136).

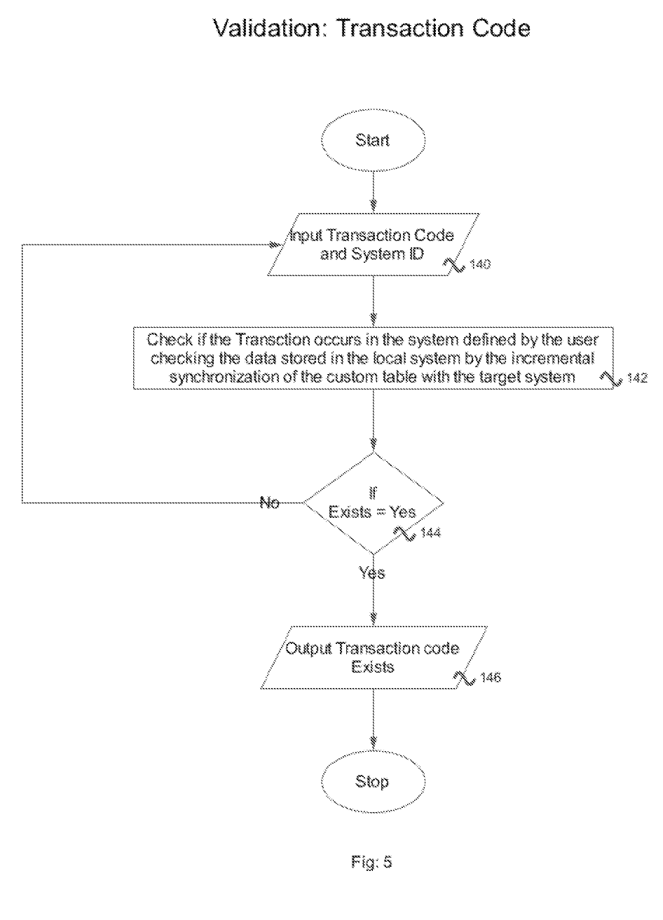

FIG. 5 shows an exemplary process for validation of a transaction code. This flowchart is part of the business process definition of FIG. 4 where the step (transaction code) is validated against the system for existence. First, the transaction code and system identification is inputted (140). Next, the process checks if the transaction occurs in the system defined by the user checking the data stored in the local system by the incremental synchronization of the custom table with the target system (142). The existence of the transaction is tested (144). If there is no transaction occurrence, the process loops back to 140 and alternatively, if transactions exist, the process outputs a code indicating the existence of the transaction (146).

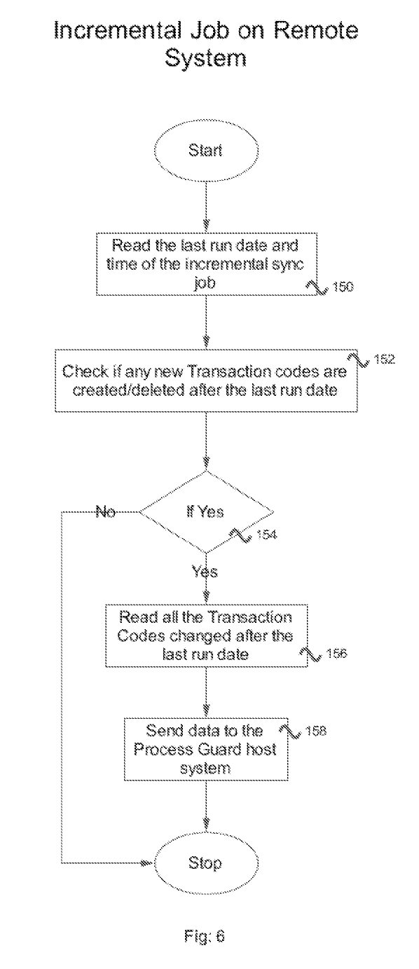

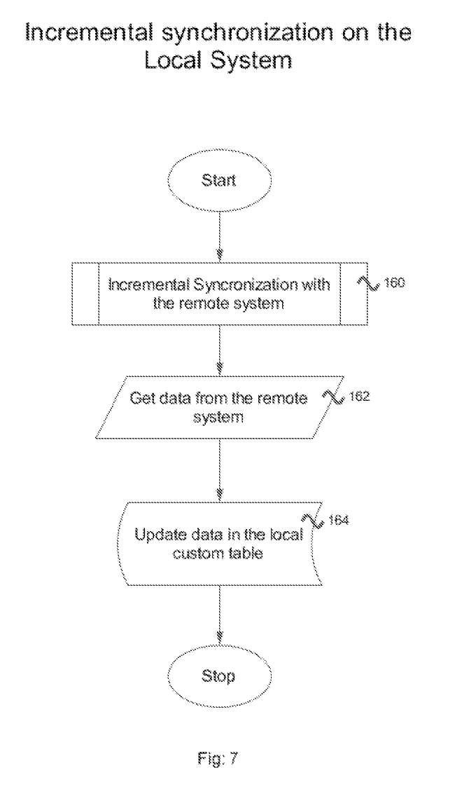

FIG. 6 shows an exemplary process to run incremental job on a remote system. The flowchart of FIG. 6 outlines a background job that is scheduled on the satellite systems to gather any additions/changes to transaction codes (business process step) and report the same back to the host system where the process guard application is running. The process reads the last run date and the time of the incremental synchronization job (150). The process then checks whether any new transaction codes have been created or deleted after the last run date (152). If the transaction codes have not been modified in 154, the process exits. Alternatively, if the transaction codes have been modified, the process reads transaction codes changed after the last run date (156) and sends the data to the process guard host system (158). The process of FIG. 6 is used in FIG. 7.

FIG. 7 shows an exemplary process to perform incremental synchronization on a local system. This flowchart includes the process of FIG. 6 to gather data from the remote system and store the same in a custom table in the local system where the process guard application is running. The process starts by performing incremental synchronization with the remote system (160). Next, data is retrieved from the remote system (162). The data is used to update a local custom table (164).

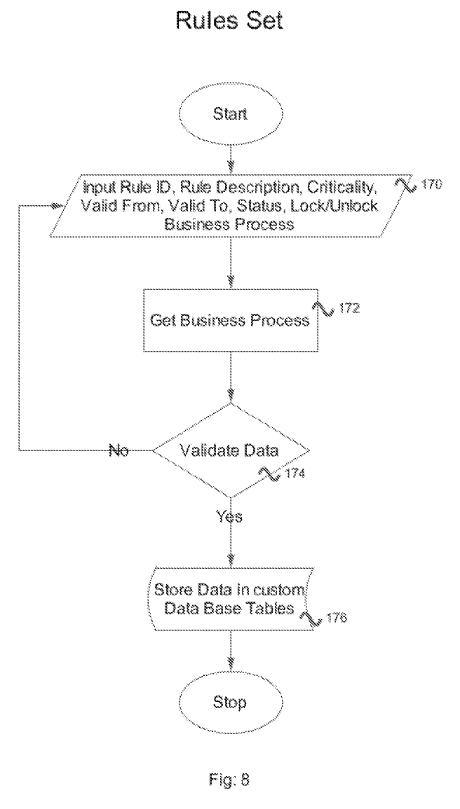

FIG. 8 shows an exemplary process to validate and store a rules set. This flowchart is part of the Rule Designer where locking rules are defined for the business processes and the locking calendar stored in a custom database table. First, the process receives as input the rule number, the rule description, the criticality of the rule, the validity dates (from and to dates), status, lock/unlock, and the business process (170). Next, the process retrieves the business process (172). The process then checks whether the data has been validated (174). If not, the process loops back to 170. Alternatively, the process stores the data in custom database tables (176) and exits.

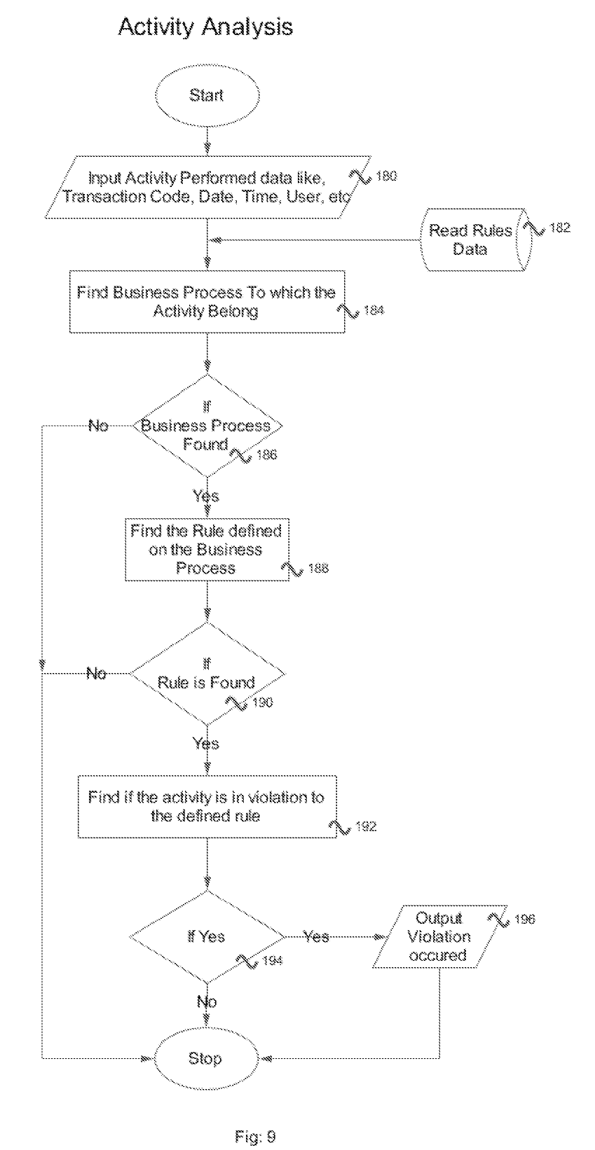

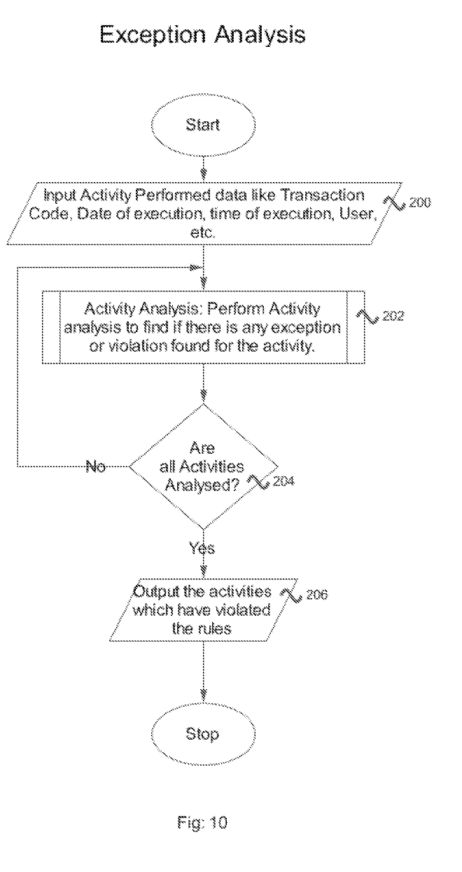

FIG. 9 shows an exemplary process to perform activity analysis. This flowchart belongs to the analytics section of Process Guard application and the activity analysis basically compares the statistical data collected against the rules defined in the rule designer to output violation, if any. This is used in the process of FIG. 10. The analysis process receives as inputs the activity being performed such as the transaction code, date, time, and user, among others (180). The process also read rules from a database table (182). The process finds the business process to which the activity belongs (184). The process determines if the business process is found (186). If not, the process exits. Alternatively, if found, the process finds the rules defined by the business process (188). If rules are found (190), the process locates activities that violate the rules (192). If there are illegal activities (194), the process generates a warning that violation(s) have occurred (196). Otherwise, the process of FIG. 9 exits.

FIG. 10 shows an exemplary process to perform exception analysis. This flowchart belongs to the analytics section of Process Guard application and exceptions are reported. Step 9 is a part of this flowchart. The process receives as input the activity being performed such as the transaction code, date, time, and user, among others (200). The process then performs an activity analysis using the process of FIG. 9 (202). The process determines if all activities have been analyzed (204). If not, the process loops back to 202 to process the next activity. Alternatively, if all activities have been processed, the process outputs activities that have violated the rules (206) and then the process of FIG. 10 exits.

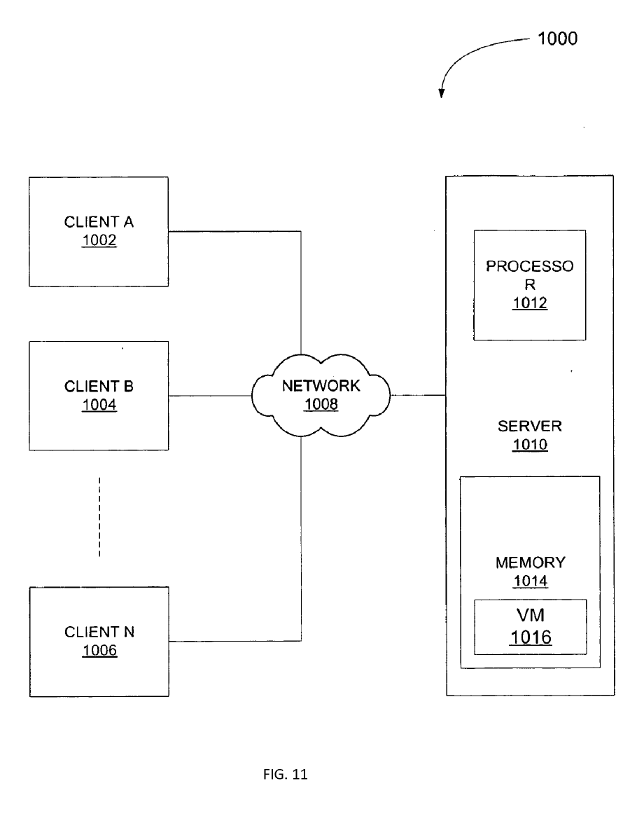

FIG. 11 illustrates an exemplary client/server system 1000 used in implementing one or more embodiments of the invention. In the illustrated embodiment, a network 1008 links a server 1010 with various client systems A-N 1002-1006. The server 1010 is a programmable data processing system suitable for implementing apparatus, programs, or methods in accordance with the description. The server 1010 provides a core operating environment for one or more runtime systems that process user requests. The server 1010 includes a processor 1012 and a memory 1014. The memory 1014 can be used to store an operating system a Transmission Control Protocol/Internet Protocol (TCP/IP) stack for communicating over the network 1008, and machine-executable instructions executed by the processor 1012. In some implementations, the server 1010 can include multiple processors, each of which can be used to execute machine-executable instructions. The memory 1014 can include a shared memory area that is accessible by multiple operating system processes executing at the server 1010. An example of a suitable server to be implemented using the client/server system 1000 may include J2EE compatible servers, such as the Web Application Server developed by SAP AG of Walldorf, Germany, or the WebSphere Application Server developed by International Business Machines Corp. of Armonk, N.Y. Client systems 1002-1006 are used to execute multiple applications or application interfaces. Each instance of an application or an application interface can constitute a user session. Each user session can generate one or more requests to be processed by the server 1010. The requests may include instructions or code to be executed on a runtime system (e.g., the virtual machine (VM) 1016) on the server 1010. A VM 1016 is an abstract machine that can include an instruction set, a set of registers, a stack, a heap, and a method area, like a real machine or processor. A VM 1016 essentially acts as an interface between program code and the actual processor or hardware platform on which the program code is to be executed. The program code includes instructions from the VM instruction set that manipulates the resources of the VM 1016.

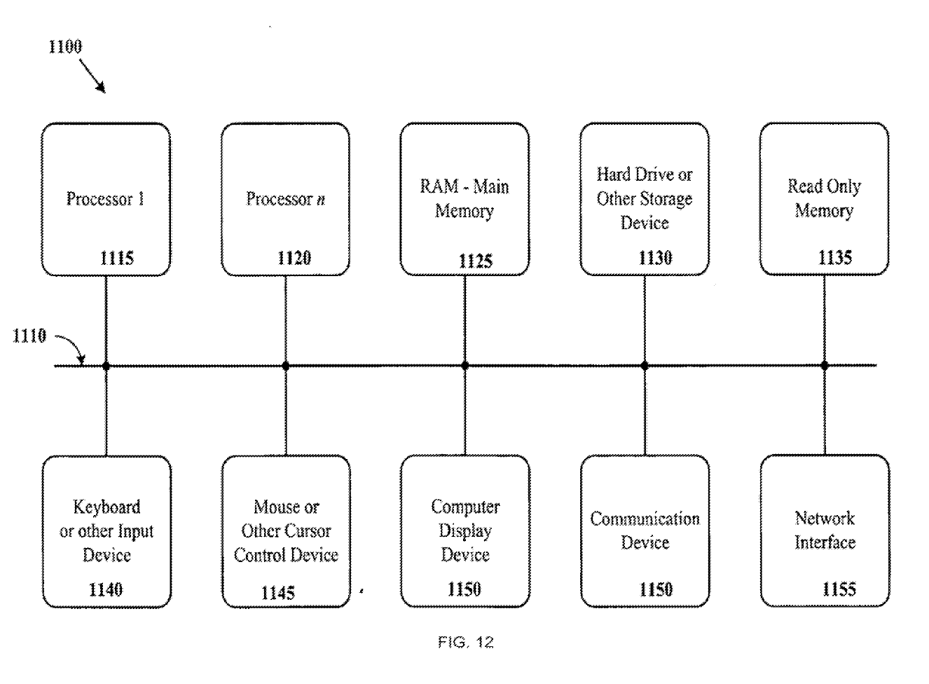

FIG. 12 is an exemplary computer system 1100 used in implementing an embodiment of the present invention. In this illustration, a system 1100 comprises a bus 1110 or other means for communicating data. The system 1100 includes one or more processors, illustrated as shown as processor 1 1115 through processor n 1120 to process information. The system 1100 further comprises a random access memory (RAM) or other dynamic storage as a main memory 1125 to store information and instructions to be executed by the processor 1115 through 1120. The RAM or other main memory 1125 also may be used for storing temporary variables or other intermediate information during execution of instructions by the processors 1115 through 1120. A hard drive or other storage device 1130 may be used by the system 1100 for storing information and instructions. The storage device 1130 may include a magnetic disk or optical disc and its corresponding drive, flash memory or other nonvolatile memory, or other memory device. Such elements may be combined together or may be separate components. The system 1100 may include a read only memory (ROM) 1135 or other static storage device for storing static information and instructions for the processors 1115 through 1120. A keyboard or other input device 1140 may be coupled to the bus 1110 for communicating information or command selections to the processors 1115 through 1120. The input device 1140 may include a keyboard, a keypad, a touch-screen and stylus, a voice-activated system, or other input device, or combinations of such devices. The computer may further include a mouse or other cursor control device 1145, which may be a mouse, a trackball, or cursor direction keys to communicate direction information and command selections to the processors and to control cursor movement on a display device. The system 1100 may include a computer display device 1150, such as a cathode ray tube (CRT), liquid crystal display (LCD), or other display technology, to display information to a user. In some environments, the display device may be a touch-screen that is also utilized as at least a part of an input device. In some environments, the computer display device 1150 may be or may include an auditory device, such as a speaker for providing auditory information. A communication device 1150 may also be coupled to the bus 1110. The communication device 1150 may include a modem, a transceiver, a wireless modem, or other interface device. The system 1100 may be linked to a network or to other device using via an interface 1155, which may include links to the Internet, a local area network, or another environment. The system 1100 may comprise a server that connects to multiple devices. In one embodiment the system 1100 comprises a Java™ compatible server that is connected to user devices and to external resources.

While the machine-readable medium 1130 is illustrated in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine of the system 1100 and that causes the machine to perform any one or more of the methodologies of the present invention. The term “machine-readable medium” shall accordingly be taken to include, but not be limited to, solid-state memories, optical and magnetic media, and carrier wave signals.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD-ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

Furthermore, it is appreciated that a lesser or more equipped computer system than the example described above may be desirable for certain implementations. Therefore, the configuration of system 1100 may vary from implementation to implementation depending upon numerous factors, such as price constraints, performance requirements, technological improvements, and/or other circumstances.

It is noted that processes taught by the discussion above can be practiced within various software environments such as, for example, object-oriented and non-object-oriented programming environments, Java based environments, such as a J2EE environment or environments defined by other releases of the Java standard), or other environments (e.g., a NET environment, a Windows/NT environment each provided by Microsoft Corporation).

It should be noted that, while the embodiments described herein may be performed under the control of a programmed processor, such as processors 1115 through 1120, in alternative embodiments, the embodiments may be fully or partially implemented by any programmable or hardcoded logic, such as field programmable gate arrays (FPGAs), TTL logic, or application specific integrated circuits (ASICs). Additionally, the embodiments of the present invention may be performed by any combination of programmed general-purpose computer components and/or custom hardware components. Therefore, nothing disclosed herein should be construed as limiting the various embodiments of the present invention to a particular embodiment wherein the recited embodiments may be performed by a specific combination of hardware components.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

While certain exemplary embodiments have been described and shown in the accompanying drawings, it is to be understood that such embodiments are merely illustrative of and not restrictive, and that the embodiments of the present invention are not to be limited to specific constructions and arrangements shown and described, since various other modifications may occur to those ordinarily skilled in the art upon studying this disclosure.

What is claimed is:

1. A method to provide a controlled process execution in an enterprise software, comprising:
a. receiving one or more rules specifying the controlled process execution;
b. capturing one or more activities performed by the enterprise software;
c. determining whether the activities performed violates the one or more rules; and
d. notifying the user of violations or exceptions caused by the activities.

2. The method of claim 1, comprising providing an automated locking mechanism for a business process.

3. The method of claim 2, wherein the locking mechanism is based on a freely definable locking calendar.

4. The method of claim 1, comprising providing an automated monitoring framework to gather business process execution statistics.

5. The method of claim 1, comprising providing analytical reports on exceptions, business process execution frequency, usage by process, transaction, user or time.

6. The method of claim 1, comprising providing a built-in approval workflow for maintaining a business process locking calendar.

7. The method of claim 1, comprising providing a user-based role proposal feature to facilitate security design.

8. The method of claim 1, comprising providing a rule designer to define a business process and setting up a rule to lock a business process based on a locking calendar to allow one or more pre-defined activities to be executed only during a predefined period.

9. The method of claim 8, wherein the predefined period comprises business hours or one or more predetermined dates.

10. The method of claim 1, comprising providing exercising control over a business process execution timing.

11. The method of claim 1, comprising preventing inadvertent or deliberate activity during a predetermined time even if permitted by a user role.

12. The method of claim 1, comprising providing an approval workflow to support a locking rule.

13. The method of claim 1, comprising utilizing one or more enhancement hooks.

14. The method of claim 13, comprising utilizing an SAP User Exit Add-in or an SAP Business Add-In.

15. The method of claim 1, comprising ensuring that one or more rules setup for temporary suspension or locking of a business process is not violated by directly unlocking the business process in a backend system.

16. The method of claim 1, comprising providing an analytics dashboard with reports to indicate exceptions, business process execution frequency by system, activity, or user.

17. The method of claim 1, comprising providing an enhancement hook in a standard SAP performance collector job.

18. The method of claim 1, comprising providing a locking/unlocking mechanism for any business process.

19. The method of claim 1, comprising collecting data for a user role design based on actual usage rather than on an arbitrary request to avoid excessive authorization.

20. The method of claim 1, wherein the enterprise software comprises an SAP system.
